(19) United States
(12) Patent Application Publication
(10) Pub. No.: US 2026/0135437 A1
(43) Pub. Date: May 14, 2026

(54) TERMINAL CONNECTOR AND ELECTRIC DRIVE ASSEMBLY

(71) Applicant: Lanto Electronic Limited, Kunshan City (CN)

(72) Inventors: Dongchang Fan, Kunshan City (CN); Yi Zhou, Kunshan City (CN)

(73) Assignee: Lanto Electronic Limited, Kunshan City (CN)

(21) Appl. No.: 19/387,293

(22) Filed: Nov. 12, 2025

(30) Foreign Application Priority Data
Nov. 13, 2024 (CN) 202411620606.5

(51) Int. Cl. H02K 5/22; H01R 9/24

(52) U.S. Cl. CPC H02K 5/225; H01R 9/2425; H01R 2201/10

(57) ABSTRACT

A terminal connector and an electric drive assembly are disclosed. A plurality of conductive members of the terminal block and the filter part are disposed in the housing, and a first connection end and the second connection end are respectively disposed at two ends of the extension body to conduct current. Thus, a plurality of first segments are disposed on the extension body, and the plurality of first segments are arranged at intervals to form an intermediate component disposed inside the magnetic ring. This allows the conductive member to pass through the magnetic ring multiple times via the intermediate component, thereby increasing the coupling strength between the terminal block and the magnetic ring and improving the filtering effect of the magnetic ring on common-mode noise. On the other hand, it avoids the need to set capacitors on the terminal connector. Thereby, the structure of the terminal connector is simplified, and its volume is made more compact.

### CLAIM OF PRIORITY AND CROSS-REFERENCE TO RELATED APPLICATION

This application claims the benefit of Chinese Patent Application No. 202411620606.5, filed on Nov. 13, 2024, which is incorporated herein by reference in its entirety.

### BACKGROUND OF THE INVENTION

### 1. Field of the Invention

The present invention relates to the field of electric vehicles technology, and particularly to a terminal connector and an electric drive assembly.

### 2. Description of the Related Art

A connector disposed between a power battery and a motor controller can transmit electrical energy from the power battery to the motor controller, which then drives a motor to rotate. Setting filter capacitors on the connector may filter noise caused by external interference or potential difference changes between signal lines. However, this also complicates the structure of the connector and increases its volume. How to simplify the structure of the connector while ensuring the filtering function has become a problem to be solved.

### BRIEF DESCRIPTION OF THE INVENTION

In view of this, an embodiment of the present disclosure provides a terminal connector and an electric drive assembly. A plurality of first segments of a conductive member are arranged at intervals to form an intermediate component disposed in a magnetic ring.

In the first aspect, a terminal connector is provided, the terminal connector comprising: a housing; a filter part, disposed in the housing and comprising a magnetic ring; and a terminal block, disposed in the housing and comprising a plurality of spaced-apart conductive members, the conductive member comprising a first connection end, a second connection end, and an extension body, at least a portion of the first connection end and at least a portion of the second connection end is exposed outside the housing; wherein the extension body extends from the first connection end to the second connection end and comprises, in an extension direction, a plurality of first segments, the plurality of first segments are arranged at intervals to form an intermediate component, the plurality of intermediate assemblies are inserted through the magnetic ring along an axial direction of the magnetic ring and coupled with the magnetic ring.

In the second aspect, the present disclosure further provides an electric drive assembly, said electric drive assembly comprising: a power module; a motor controller; and the terminal connector according to the first aspect described above, wherein the first connection end is connected to the power module, and the second connection end is connected to the motor controller.

The present disclosure provides a terminal connector and an electric drive assembly. A plurality of conductive members of the terminal block and the filter part are disposed in the housing, and a first connection end and the second connection end are respectively disposed at two ends of the extension body to conduct current. Thus, a plurality of first segments are disposed on the extension body, and the plurality of first segments are arranged at intervals to form an intermediate component disposed inside the magnetic ring. This allows the conductive member to pass through the magnetic ring multiple times via the intermediate component.

### BRIEF DESCRIPTION OF THE DRAWINGS

FIG. 1 is a structural schematic diagram of one side of a terminal connector according to an embodiment of the present disclosure;

FIG. 2 is a structural schematic diagram of another side of the terminal connector according to an embodiment of the present disclosure;

FIG. 3 is an exploded view of one side of the terminal connector according to an embodiment of the present disclosure;

FIG. 4 is an exploded view of another side of the terminal connector according to an embodiment of the present disclosure;

FIG. 5 is a cross-sectional view taken along line A-A in FIG. 1;

FIG. 6 is a structural schematic diagram of one side of a conductive member according to an embodiment of the present disclosure;

FIG. 7 is a structural schematic diagram of another side of the conductive member according to an embodiment of the present disclosure;

FIG. 8 is an exploded view of a terminal block according to an embodiment of the present disclosure;

FIG. 9 is a structural schematic diagram of a filter part according to an embodiment of the present disclosure;

FIG. 10 is a structural schematic diagram of an extension section according to an embodiment of the present disclosure;

FIG. 11 is a structural schematic diagram of an extension section and a side segment according to an embodiment of the present disclosure;

FIG. 12 is a circuit schematic diagram of an electric drive assembly according to an embodiment of the present disclosure.

### DETAILED DESCRIPTION OF EMBODIMENTS OF THE INVENTION

Several preferred embodiments of the present disclosure will be described in detail in conjunction with the accompanying drawings as follows, however, the present disclosure is intended to encompass any substitutions, modifications, equivalents, etc., made thereto without departing from the spirit and scope of the present disclosure. In order to provide those skilled in the art with thorough understanding of the present disclosure, particular details will be described below in the preferred embodiments of the present disclosure, although those skilled in the art can understand the present disclosure without the description of these details.

In addition, it should be understood by those skilled in the art that the accompanying drawings are provided herein for purposes of illustration and that the accompanying drawings are not necessarily to scale.

Furthermore, it should be understood that the terms “circuit” used herein refer to conductive circuits formed by at least one component or sub-circuit that are electrically or electromagnetically connected. When an element or circuit is referred to as “connected to” another element or “connected between” two nodes, it may be directly coupled or connected to another element or there may be intermediate elements, and the connection between elements may be physical, logical, or a combination thereof. Conversely, when an element is referred to as “directly coupled to” or “directly connected to” another element, it means that there are no intermediate elements between the two.

Unless otherwise specified and limited, the terms “mounted,” “connected,” “fixed,” and similar terms should be broadly understood, for example, they may be fixed connections or detachable connections, or integrated; they may be mechanical connections or electrical connections; they may be directly connected or indirectly connected through intermediate media, and can be an internal connection or interaction relationship between two elements, unless otherwise specified. To those skilled in the art, the specific meaning of the above terms in this disclosure may be understood on a case-by-case basis.

For ease of illustration, spatially relative terms such as “inside,” “outside,” “below,” “underneath,” “lower part,” “upper part,” “above,” etc., are used herein to describe the relationship between one component or feature and another component or feature in the drawings. It will be understood that spatially relative terms may encompass different orientations of the device during use or operation other than those depicted in the figures. For example, if the device in the figures is flipped, the component described as being “below” or “underneath” another component or feature will then be positioned as being “above” that other component or feature. Thus, the example term “below” may encompass both above and below orientations. The device may be oriented in other ways (rotated 90 degrees or in other orientations), and the spatially relative descriptive words used herein should be interpreted accordingly.

Unless the context clearly requires otherwise, the terms “include,” “comprise,” and similar terms throughout the specification should be interpreted as meaning “including but not limited to,” that is, they have an inclusive meaning rather than an exhaustive one.

In the description of the present application, it should be understood that the terms “first,” “second,” and so on are used for descriptive purposes only and should not be construed as indicating or implying relative importance. Furthermore, in the description of the present application, unless otherwise specified, the term “multiple” means two or more.

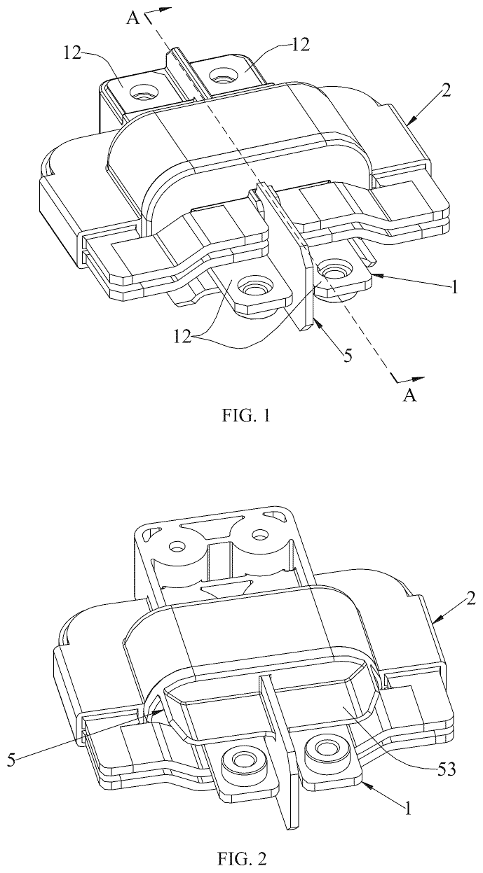

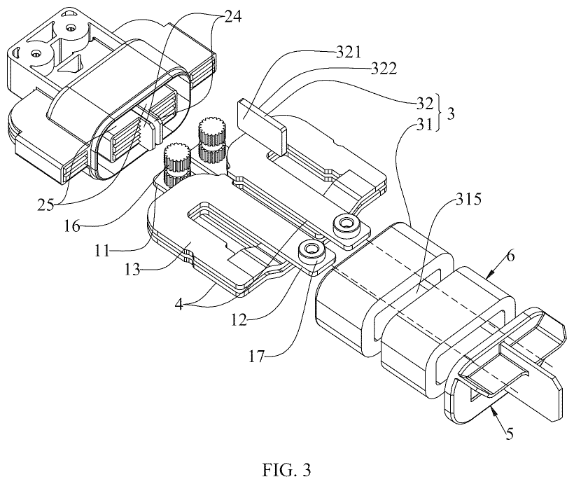

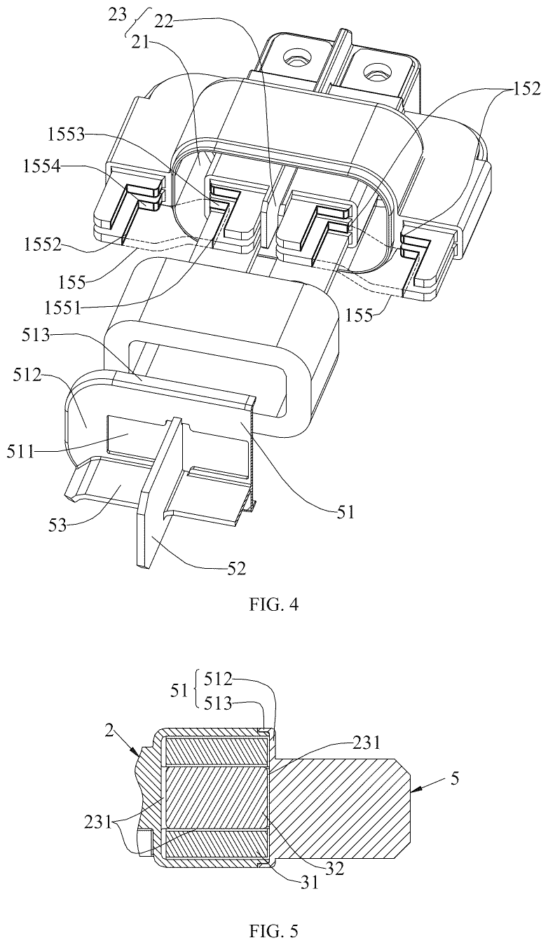

FIGS. 1 and 2 are structural schematic diagrams of the terminal connector according to the present embodiment. FIGS. 3 and 4 are exploded views of the terminal connector according to the present embodiment.

In some embodiments, as shown in FIGS. 1-2, the terminal connector in this embodiment includes a housing 2, and a terminal block 1, a filter part 3, and a cover part 5 provided in the housing 2. Further referring to FIGS. 3-4, the terminal block 1 includes a plurality of spaced-apart conductive members 4. Each conductive member 4 is respectively used to form an electrical path. The conductive member 4 sequentially includes, in its extension direction, a first connection end 11, an extension body 13, and a second connection end 12. At least a portion of the first connection end 11 and at least a portion of the second connection end 12 are exposed outside the housing 2.

Specifically, the filter part 3 in this embodiment is used to filter noise on the terminal block 1. This noise includes, but is not limited to, common-mode noise and differential-mode noise. Thereby, noise on the terminal block 1 is prevented from interfering with the electrical equipment connected to the second connection end 12. Common-mode noise refers to the same noise appearing simultaneously on both the positive and negative poles of a signal line, that is, a disturbance in the same direction of the potential of the two signal lines relative to ground (or a reference point). Differential-mode noise refers to noise appearing between the positive and negative poles of a signal line, that is, noise caused by changes in the potential difference between the two signal lines.

Specifically, as shown in FIG. 1, the first connection end 11 extends linearly and has a first contact surface. The second connection end 12 extends linearly and has a second contact surface. The first contact surface is exposed outside the housing 2, and both the first contact surface and the second contact surface are planar and face the upper side of the terminal connector. Current can be conducted from the first connection end 11 to the second connection end 12, or from the second connection end 12 to the first connection end 11. This enables the first connection end 11 and the second connection end 12 to be electrically connected to other devices.

Optionally, the conductive member 4 in this embodiment may be made of a conductive material such as copper (e.g., T2 copper) or an alloy. The housing 2 may be made of a non-conductive material such as rubber, plastic, or polymer. Thereby, a creepage distance between the plurality of conductive members 4 spaced apart in the housing 2 is ensured.

FIG. 5 is a cross-sectional view taken along line A-A in FIG. 1. The filter part 3 in the figure includes a magnetic ring 31 and an intermediate magnetic body 32 located inside the magnetic ring 31. The housing 2 snaps together with the cover part 5, thereby fixing the filter part 3 inside the terminal connector. The material of the magnetic ring 31 may be a nanocrystalline material. The magnetic ring 31 may filter common-mode noise.

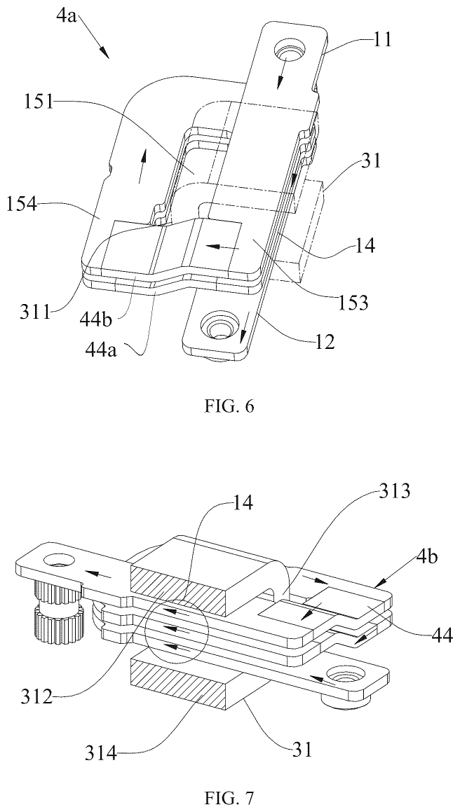

FIGS. 6 and 7 are structural schematic diagrams of the conductive member 4, where the conductive member 4 in FIG. 6 is a first conductive member 4a, and the conductive member 4 in FIG. 7 is a second conductive member 4b. The arrows in the two figures show a specific current flow direction. That is, the direction of current flow may vary depending on the connection method of the terminal connector. Furthermore, the winding direction of the first conductive member 4a is opposite to that of the second conductive member 4b.

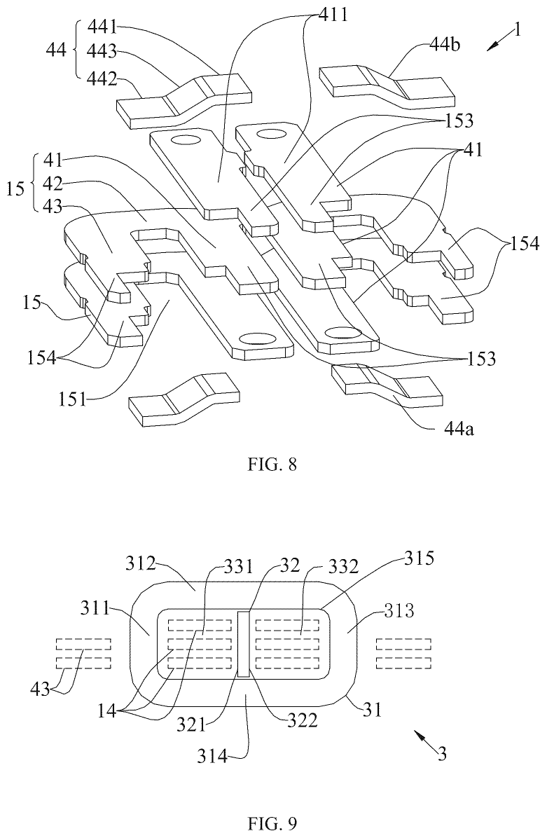

FIG. 8 is an exploded view of the terminal block 1 according to the present embodiment.

In some embodiments, as shown in FIGS. 5-8, the extension body 13 extends from the first connection end 11 to the second connection end 12 and includes, in the extension direction, a plurality of first segments 41. The plurality of first segments 41 are arranged at intervals to form an intermediate component 14. The plurality of intermediate assemblies 14 are inserted through the magnetic ring 31 along the axial direction of the magnetic ring 31 and are coupled with the magnetic ring 31. The extension body 13 may be configured as a strip-like structure. In the extension direction of the strip-like structure, the plurality of first segments 41 are arranged at intervals, and in the thickness direction of the strip-like structure, the plurality of first segments 41 are spaced apart.

The number of first segments 41 in this embodiment may be two, three, or more. When the number of first segments 41 is plural, compared to setting only one first segment 41, the coupling strength between the conductive member 4 and the magnetic ring 31 can be increased, improving the filtering effect of the filter part 3 on noise in specific frequency bands on the terminal block 1. The magnetic ring 31 can filter common-mode noise on the terminal block 1, reducing interference caused by common-mode noise to the electrical equipment connected to the second connection end 12.

In summary, the terminal connector in this embodiment disposes the plurality of conductive members 4 of the terminal block 1 and the filter part 3 in the housing 2, and disposes the first connection end 11 and the second connection end 12 respectively at the two ends of the extension body 13 to conduct current. Thus, a plurality of first segments 41 are disposed on the extension body 13, and the plurality of first segments 41 are arranged at intervals to form the intermediate component 14 disposed inside the magnetic ring 31. This allows the conductive member 4 to pass through the magnetic ring 31 multiple times via the intermediate component 14, thereby increasing the coupling strength between the terminal block 1 and the magnetic ring 31 and improving the filtering effect of the magnetic ring 31 on common-mode noise within specific frequency bands. On the other hand, it avoids the need to set capacitors on the terminal connector. Thereby, the structure of the terminal connector is simplified, and its volume is made more compact.

FIG. 9 is a structural schematic diagram of the filter part 3 according to the present embodiment.

In some embodiments, as shown in FIGS. 6 and 9, the magnetic ring 31 includes a first sidewall 311 in a circumferential direction. The inner surface of the magnetic ring 31 forms a central hole 315, and the intermediate component 14 is located in the central hole 315. The extension body 13 extends curvilinearly and winds around the first sidewall 311 for multiple turns. The first connection end 11 and the second connection end 12 extend out from the two ends of the central hole 315.

Thus, the conductive member 4 in this embodiment is arranged around the first sidewall 311, which may enhance the coupling strength between the conductive member 4 and the magnetic ring 31, allowing the current flowing along the extension body 13 to pass through the central hole 315 multiple times, further enhancing the filtering effect of the magnetic ring 31. Additionally, it can reduce the volume occupied by the terminal block 1.

Optionally, the extension body 13 may wind around the first sidewall 311 for two turns, three turns, or more. Taking FIG. 6 as an example, the extension body 13 in the figure winds around the first sidewall 311 for two full turns and then another half turn. This causes the first connection end 11 and the second connection end 12 to be located on opposite sides of the magnetic ring 31, facilitating the installation operation of the terminal connector.

In some embodiments, as shown in FIGS. 6 and 8, the extension body 13 further includes, in the extension direction, a connection segment 44 and an extension section 15. The extension section 15 is curved to form an accommodation gap 151.

Further referring to FIG. 4, the accommodation gap 151 has a first opening 152, and the orientations of the first openings 152 of each conductive member 4 are the same. The extension section 15 includes the aforementioned first segment 41. A portion of the first sidewall 311 is disposed within the accommodation gap 151, and the first sidewall 311 does not contact the accommodation gap 151. The connection segment 44 is located on the side of the extension section 15 where the first opening 152 is disposed. The extension section 15 is electrically connected to the first connection end 11 or the second connection end 12 via the connection segment 44.

During the assembly process of the terminal connector in this embodiment, the magnetic ring 31 may be disposed in the accommodation gap 151 through the first opening 152. In this form, various regions of the extension body 13 are in a discontinuous state. Then, the connection segment 44 is disposed at the position of the first opening 152, causing the various regions of the extension body 13 to be electrically bridged together via the connection segment 44, thereby forming an electrical path. Thus, the installation method of the terminal block 1 is simplified, allowing the conductive member 4 to be wound around the first sidewall 311 roughly in a spiral form, improving the coupling strength between the conductive member 4 and the magnetic ring 31, and making the structure of the terminal block 1 more compact.

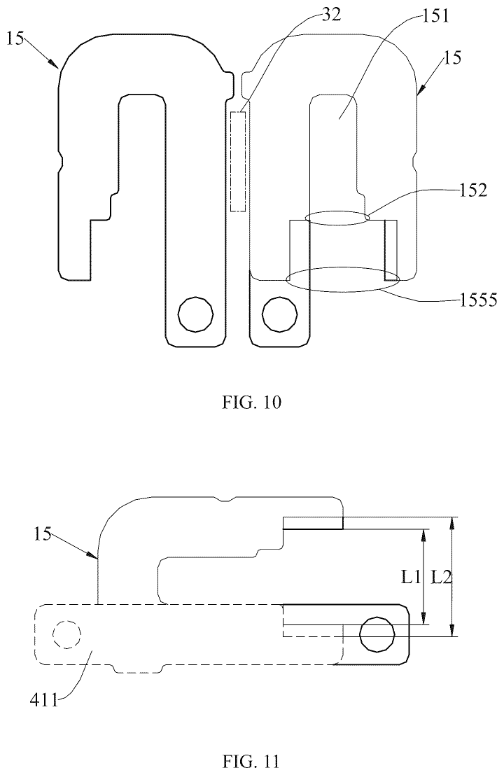

FIG. 10 is a structural schematic diagram of the extension section 15 according to the present embodiment. The outline of the lower extension section 15 in the figure is shown with a thick solid line; only one extension section 15 is shown on the left side.

In some embodiments, as shown in FIG. 8, the extension body 13 includes, in the extension direction, a plurality of extension sections 15 arranged at intervals. Further referring to FIG. 10, in the arrangement direction of the plurality of extension sections 15, the plurality of accommodation gaps 151 of the same conductive member 4 at least partially overlap and correspond to the first sidewall 311. Thus, the magnetic ring 31 may be sleeved outside the intermediate component 14 through the accommodation gap 151, avoiding interference between the first sidewall 311 and the extension section 15.

Optionally, the plurality of extension sections 15 extend on different planes respectively, and the edges of the plurality of accommodation gaps 151 completely overlap, causing the distance from the first sidewall 311 to each accommodation gap 151 to remain the same, thereby ensuring stable coupling with the magnetic ring 31 each time the extension body 13 passes through the central hole 315.

In some embodiments, as shown in FIGS. 6 and 8, the extension section 15 further includes a second segment 42 and a third segment 43. The third segment 43 is disposed outside the magnetic ring 31. The third segment 43 and the first segment 41 extend parallel to each other along the axial direction of the magnetic ring 31 and are connected by the second segment 42. A portion of the first segment 41 has a first connection tab 153. The third segment 43 has a second connection tab 154. The first connection tab 153 and the second connection tab 154 are located on the side of the extension section 15 away from the second segment 42. Each first connection tab 153 is located on the same side of the conductive member 4. The plurality of first segments 41 include a side segment 411. The side segment 411 is located on the same side as each extension section 15, and one end of the side segment 411 is connected to the first connection end 11, and the other end forms the first connection tab 153. The connection segment 44 is connected between two adjacent extension sections 15 or between an adjacent side segment 411 and extension section 15, and the two ends of the connection segment 44 are connected to the first connection tab 153 and the second connection tab 154 respectively.

Specifically, one first segment 41 serves as the side segment 411 disposed at the top of the terminal block 1. Current fed into the terminal block 1 may first pass through the magnetic ring 31 via the side segment 411 to filter common-mode noise. The extension section 15 may be configured as a U-shaped structure, with the notch of the U-shaped structure facing the same side of the housing 2. The extension section 15 may be manufactured by laser cutting a metal plate or using a stamping process, to reduce the processing cost of the terminal block 1.

In some embodiments, as shown in FIG. 8, the connection segment 44 includes a first connection block 441, a second connection block 442, and a bent region 443 connected between the first connection block 441 and the second connection block 442. Further referring to FIG. 6, the first connection block 441 is connected to the first connection tab 153 and lies in the same plane as the first connection tab 153. The second connection block 442 is connected to the second connection tab 154 and lies in the same plane as the second connection tab 154. The bent region 443 bends from one plane to an adjacent plane.

The first connection block 441 and the second connection block 442 in this embodiment are in the same plane as the first connection tab 153 and the second connection tab 154 respectively, making it easier for an operator to weld (e.g., laser weld) the first connection tab 153 and the second connection tab 154 to the first connection block 441 and the second connection block 442, thereby reducing the welding difficulty and ensuring the mechanical strength of the conductive member 4 after welding.

In some embodiments, as shown in FIGS. 2 and 4, the housing 2 is an injection-molded part and has an accommodation ring groove 21. The accommodation ring groove 21 surrounds the intermediate component 14. The terminal block 1 is disposed as an insert in the housing 2, and the first connection tab 153 and the second connection tab 154 protrude from the housing 2.

Specifically, the housing 2 and part of the conductive member 4 in this embodiment may be manufactured using an insert molding process, thereby fixing the intermediate component 14 inside the housing 2 and exposing the first connection tab 153 and the second connection tab 154 outside the housing 2 to form an injection-molded assembly. Thus, the operator may first place the magnetic ring 31 in the accommodation ring groove 21, and then connect the connection segment 44 between the first connection tab 153 and the second connection tab 154. Thereby, the extension body 13 can wind around the sidewall of the magnetic ring 31.

In some embodiments, as shown in FIG. 4, a connection window 155 is formed between the first connection tab 153 and the second connection tab 154 corresponding to the same connection segment 44. The dashed line in FIG. 4 shows the general outline of the lower connection window 155. The magnetic ring 31 passes through the connection window 155 and is disposed in the accommodation ring groove 21. Further referring to FIG. 8, the connection segment 44 is disposed at the connection window 155.

The connection segment 44 in this embodiment is fixedly connected to the extension section 15 through the connection window 155. Before the connection segment 44 is connected to the extension section 15, the accommodation ring groove 21 is open towards one side of the terminal connector through the connection window 155, facilitating the passage of the magnetic ring 31 through the connection window 155 into the accommodation ring groove 21.

In some embodiments, as shown in FIG. 3, the terminal connector further includes a cover part 5. Further referring to FIG. 4, the cover part 5 includes a cover body 51. The cover body 51 is provided with an avoidance window 511. The cover part 5 passes through the connection window 155 and covers the accommodation ring groove 21, and the first connection tab 153 and the second connection end 12 protrude from the avoidance window 511.

Specifically, the cover body 51 includes a side plate 512. The side plate 512 extends around to form the avoidance window 511. When the cover body 51 covers the accommodation ring groove 21, the side plate 512 may protect the magnetic ring 31. In this form, part of the side plate 512 may just pass through the connection window 155. Thereby, the structure of the cover part 5 matches that of the injection-molded assembly.

In some embodiments, as shown in FIG. 9, the magnetic ring 31 further includes, in the circumferential direction, a second sidewall 312 connected to the first sidewall 311. Further referring to FIG. 4, the connection window 155 has a first window edge 1551 disposed at the first connection tab 153 and a second window edge 1552 disposed at the second connection tab 154. The first window edge 1551 and the second window edge 1552 are opposite to each other and parallel to the axial direction of the magnetic ring 31. The first window edge 1551 and the second window edge 1552 are welded to the two ends of the connection segment 44 respectively. In the arrangement direction of the third segment 43 and the first segment 41, the first window edge 1551 and the second window edge 1552 of the connection window 155 away from the second sidewall 312 are located between the first window edge 1551 and the second window edge 1552 of the connection window 155 close to the second sidewall 312.

FIG. 11 is a structural schematic diagram of the extension section 15 and the side segment 411 according to the present embodiment. The outline of the upper side segment 411 in the figure is shown with a dashed line; the outline of the lower extension section 15 is shown with a thick solid line.

Specifically, as shown in FIG. 11, in the arrangement direction of the two extension sections 15, the distance between the first window edge 1551 and the second window edge 1552 of the lower connection window 155 is distance L1, and the distance between the first window edge 1551 and the second window edge 1552 of the upper connection window 155 is distance L2. The distance L1 is less than the distance L2. That is, the lower first window edge 1551 and second window edge 1552 are located inside the upper connection window 155.

Specifically, the connection segment 44 includes a first connection segment 44a and a second connection segment 44b. The first connection segment 44a and the second connection segment 44b extend parallel to each other, and the length of the first connection segment 44a is less than that of the second connection segment 44b. When the operator places the first connection segment 44a in the lower connection window 155, the welding positions of the first connection segment 44a with the first window edge 1551 and the second window edge 1552 will pass through the upper connection window 155 and face the upper side of the injection-molded assembly. Thus, the operator may use a laser welding beam or welding head to weld the second connection segment 44b, and the upper connection window 155 may serve to avoid the beam or welding head. After the second connection segment 44b is welded, the first connection segment 44a may then be welded.

Specifically, the conductive member 4 includes two extension sections 15, a first connection segment 44a, a second connection segment 44b, and one side segment 411. The first segment 41 of the extension section 15 away from the side segment 411 is connected to the second connection end 12. The extension section 15 close to the side segment 411 is connected to the side segment 411 via the second connection segment 44b, and the side segment 411 is connected to the first connection end 11.

In some embodiments, as shown in FIG. 4, the connection window 155 has a third window edge 1553 disposed at the first connection tab 153 and a fourth window edge 1554 disposed at the second connection tab 154. The third window edge 1553 and the fourth window edge 1554 extend along the arrangement direction of the first segment 41 and the third segment 43, and the opposite sides of the third window edge 1553 and the fourth window edge 1554 form the first opening 152. Further referring to FIG. 6, a side edge of the connection segment 44 is spliced with the third window edge 1553 and the fourth window edge 1554 and faces an end surface of the magnetic ring 31 through the first opening 152.

The third window edge 1553 and the fourth window edge 1554 in this embodiment may play a position limiting role for the connection segment 44, ensuring the positional accuracy between the connection segment 44 and the extension section 15 after welding. Meanwhile, the third window edge 1553 and the fourth window edge 1554 may also increase the contact area between the connection segment 44 and the extension section 15, helping to improve current conduction.

Specifically, as shown in FIG. 10, a second opening 1555 is provided on the side of the connection window 155 away from the first opening 152. The accommodation gap 151 is open towards one side of the extension section 15 through the second opening 1555. The magnetic ring 31 may, sequentially through the second opening 1555 and the first opening 152, enter the accommodation gap 151.

In some embodiments, as shown in FIGS. 6-7, the plurality of conductive members 4 include a first conductive member 4a and a second conductive member 4b. Further referring to FIG. 9, the magnetic ring 31 further includes, in the circumferential direction, a third sidewall 313. The third sidewall 313 is spaced apart from and opposite to the first sidewall 311. The extension body 13 of the first conductive member 4a winds around the first sidewall 311. The extension body 13 of the second conductive member 4b winds around the second sidewall 312. The extension direction of the extension body 13 of the first conductive member 4a is opposite to the extension direction of the extension body 13 of the second conductive member 4b, and the number of turns of the extension body 13 of the first conductive member 4a is the same.

The first conductive member 4a and the second conductive member 4b in this embodiment may respectively serve as the positive transmission line and the negative transmission line, thereby providing DC power to electrical equipment. Meanwhile, the winding directions of the two extension bodies 13 are opposite, and the number of turns is configured to be the same. This can make the inductance values of the positive transmission line and the negative transmission line consistent, contributing to stable current conduction. Moreover, different areas of the magnetic ring 31 are fully utilized.

In some embodiments, as shown in FIG. 3, the filter part 3 further includes an intermediate magnetic body 32. It is disposed spaced apart between the first conductive member 4a and the second conductive member 4b, and the intermediate magnetic body 32 is coupled with the first conductive member 4a, the second conductive member 4b, and the magnetic ring 31. The intermediate magnetic body 32 in this embodiment may cooperate with the magnetic ring 31 to filter differential-mode noise on the terminal block 1. Thereby, the installation of capacitors on the terminal connector is avoided, further simplifying the structure of the terminal connector.

In some embodiments, as shown in FIGS. 3 and 9, the intermediate magnetic body 32 is a plate-like structure. The plate-like structure has a first plate surface 321 and a second plate surface 322. The first plate surface 321 faces the first sidewall 311. A first coupling space 331 is formed between the first plate surface 321 and the first sidewall 311. The second plate surface 322 faces the third sidewall 313. A second coupling space 332 is formed between the second plate surface 322 and the third sidewall 313. The intermediate component 14 of the first conductive member 4a and the intermediate component 14 of the second conductive member 4b are located in the first coupling space 331 and the second coupling space 332, respectively.

The intermediate magnetic body 32 and the first sidewall 311 in this embodiment may be equivalent to the two plates of a first capacitor, and the intermediate magnetic body 32 and the third sidewall 313 may be equivalent to the two plates of a second capacitor. The magnetic lines of force of the first capacitor and the second capacitor pass through the two intermediate assemblies 14 respectively, thereby filtering the differential-mode noise of the two intermediate assemblies 14.

Optionally, the outer surface of the magnetic ring 31 in this embodiment is provided with epoxy resin, making the outer side of the magnetic ring 31 more regular in shape. The intermediate magnetic body 32 may be made of a ferrite material.

In some embodiments, as shown in FIG. 4, the housing 2 has a mounting groove 23. The mounting groove 23 includes an accommodation ring groove 21 and an intermediate groove 22 communicating with each other. The intermediate groove 22 is located at the center of the accommodation ring groove 21 and is located between the two intermediate assemblies 14. Further referring to FIG. 5, the magnetic ring 31 is disposed in the accommodation ring groove 21. The intermediate magnetic body 32 is disposed in the intermediate groove 22, and a partial filling gap 231 is formed between the filter part 3 and the inner wall of the mounting groove 23. The terminal connector further includes a filling adhesive 6. The filling adhesive 6 fills the aforementioned filling gap 231. The filling adhesive 6 in this embodiment may simplify the fixing method of the filter part 3 to the housing 2.

Specifically, the filling adhesive 6 in this embodiment may be a silicone rubber adhesive, such as two-component silicone rubber, RTV silicone rubber adhesive, or heat vulcanized silicone rubber adhesive (HTV). After the filling adhesive 6 cures, it fix the filter part 3 inside the housing 2. Additionally, the filter part 3 may also play roles in impact resistance and heat conduction.

In some embodiments, as shown in FIG. 8, a portion of the first segment 41 has a first connection tab 153. Further referring to FIGS. 4 and 5, the terminal connector further includes a cover part 5. The cover part 5 includes a cover body 51 and a partition plate 52. The cover body 51 is provided with an avoidance window 511. The cover body 51 covers the accommodation ring groove 21. The first connection tab 153 and the second connection end 12 protrude from the avoidance window 511. Further referring to FIG. 1, the partition plate 52 is simultaneously located between the two intermediate assemblies 14 and between the two second connection ends 12, and a plate edge of the partition plate 52 extends into the intermediate groove 22. The filling gap 231 is formed between the magnetic ring 31 and the mounting groove 23 and the cover body 51. Thereby, the filling adhesive 6 fix the cover part 5 and the housing 2 together.

Specifically, as shown in FIG. 3, the partition plate 52 in this embodiment is used to separate the first connection end 11 and the second connection end 12, preventing the two conductive members 4 exposed outside the housing 2 from contacting each other and causing a short circuit. Simultaneously, it also provides sufficient creepage distance between the first conductive member 4a and the second conductive member 4b. The housing 2 further includes two intermediate blocks 25 and two intermediate plates 24. The outer side surfaces of the two intermediate blocks 25 are used to form the inner wall of the accommodation ring groove 21. The two intermediate plates 24 are disposed on the opposite sides of the two intermediate blocks 25. The opposite sides of the two intermediate blocks 25 form the intermediate groove 22. The two intermediate plates 24 extend to the outside of the accommodation ring groove 21. The edges of the two intermediate plates 24 pass through the avoidance window 511 and extend to both sides of the edge of the partition plate 52, thereby limiting the cover part 5.

Optionally, the cover body 51 further includes a flange 513. The flange 513 is disposed at the edge of the cover body 51 and bends towards the housing 2. After the cover part 5 is fixed to the housing 2, the top of the accommodation ring groove 21 may be inserted into the flange 513, thereby protecting the filter part 3 and also reducing the flow of the filling adhesive 6 to the outside.

In some embodiments, as shown in FIGS. 2 and 4, the cover part 5 further includes a baffle plate 53. The baffle plate 53 protrudes from the side of the cover body 51 facing away from the accommodation ring groove 21. The baffle plate 53 is located on the side of the first connection end 11 and the second connection end 12 facing away from the first contact surface and the second contact surface. Simultaneously, the baffle plate 53 is connected to the partition plate 52 to reinforce the partition plate 52. When the electrical equipment is butted with the first contact surface and the second contact surface, the baffle plate 53 can limit the bending amplitude of the first connection end 11 and the second connection end 12, preventing excessive bending. The cover part 5 may be an injection-molded part, for example, made of polyurethane, to ensure sufficient strength of the cover part 5.

In some embodiments, as shown in FIG. 9, a cross-section along the extending direction of the central hole 315 is a rounded rectangle. The first sidewall 311 and the third sidewall 313 respectively form the two short sides of the rounded rectangle. The two intermediate assemblies 14 are arranged along the long side of the rounded rectangle. The plurality of first segments 41 of the same intermediate component 14 are arranged along the short side of the rounded rectangle. Thereby, the shape of the magnetic ring 31 better adapts to the first conductive member 4a and the second conductive member 4b.

Specifically, the magnetic ring 31 further includes a fourth sidewall 314. The fourth sidewall 314 is spaced apart from and parallel to the second sidewall 312. The intermediate magnetic body 32 is located at the center of the magnetic ring 31, and the distances to the first sidewall 311 and the third sidewall 313 are the same. The intermediate assemblies 14 of the first conductive member 4a and the second conductive member 4b are symmetrically disposed on both sides of the intermediate magnetic body 32 and do not contact the filter part 3.

It is easy to understand that the coupling strength between the conductive member 4 and the filter part 3 is positively correlated with the inductance value of the conductive member 4. The inductance value of the conductive member 4 can be estimated according to the formula L=N²×AL. Where N is the number of turns of the conductive member 4 wound on the magnetic ring 31, and AL is the inductance value per turn of the conductive member 4. It can be seen that when the conductive member 4 includes three first segments 41, that is, the conductive member 4 passes through the magnetic ring 31 three times, the inductance value of the conductive member 4 increases by approximately 9 times compared to a single turn.

TABLE 1

| | | |
|---|---|---|
| Frequency | Single Turn | Three Turns |

| | | | | | |
|---|---|---|---|---|---|
| 10 | kHz | 25.94 | uH | 237.12 | uH |
| | | 1.64 | Ω | 14.94 | Ω |
| 100 | kHz | 20.84 | uH | 9.64 | uH |
| | | 14.28 | Ω | 186.52 | Ω |
| 30 | MHz | 26.41 | Ω | 427.09 | Ω |

Table 1 is a comparison of inductance and impedance values for the terminal connector at 10 kHz, 100 kHz, and 30 MHz, for a single turn (number of first segments 41 is one) and three turns (number of first segments 41 is three). In the table, the unit for inductance is microhenries (μH), and the unit for impedance is ohms (Ω). Taking 10 kHz as an example, the inductance value for three turns is roughly 9 times that for a single turn. This shows that the filter part 3 can effectively filter the noise of the conductive member 4.

TABLE 2

| | | |
|---|---|---|
| Frequency | Single Turn (dB) | Three Turns (dB) |

| | | | |
|---|---|---|---|
| 10 | kHz | 0.01 | −0.36 |
| 100 | kHz | −1.09 | −9.64 |
| 1 | MHz | −5.36 | −19.35 |
| 10 | MHz | −9.05 | −25.93 |
| 30 | MHz | −2.74 | −19.55 |
| 50 | MHz | −1.15 | −13.43 |
| 100 | MHz | 0.5 | −6.29 |

Table 2 shows the insertion loss (dB) of the terminal connector at different frequencies, for a single turn (number of first segments 41 is one) and three turns (number of first segments 41 is three). Taking 10 kHz as an example, the insertion loss for three turns is less than that for a single turn. Therefore, the filter part 3 may couple well with the terminal block 1 and filter the noise of the conductive member 4.

The terminal connector in the above embodiments may be installed in the following manner. In some embodiments, first, the extension section 15 is manufactured using a laser cutting process or a stamping process. As shown in FIG. 3, the first nut 16 is fixed to the first connection end 11, and aligning the first nut 16 with the through hole of the first connection end 11. Secondly, using an insert molding process, the extension section 15 and the first nut 16 are injection molded together with the housing 2. Next, the filling adhesive 6 is applied inside the mounting groove 23, and the magnetic ring 31 and the intermediate magnetic body 32 are placed in the accommodation ring groove 21 and the intermediate groove 22, respectively. The filling adhesive 6 is applied to the outer end surface of the magnetic ring 31. Then, the cover part 5 is placed over the accommodation ring groove 21. Afterwards, the first connection segment 44a and the second connection segment 44b are sequentially welded to the corresponding connection windows 155. Finally, the second nut 17 is fixed to the second connection end 12, aligning the second nut 17 with the through hole of the second connection end 12.

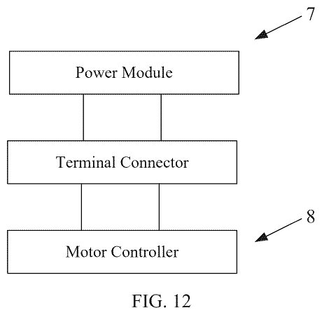

FIG. 12 is a circuit schematic diagram of the electric drive assembly according to the present embodiment.

In an optional implementation, as shown in FIG. 12, the terminal connector described in the above embodiments may be applied to an electric drive assembly. The electric drive assembly further includes a power module 7 and a motor controller 8.

Specifically, the power module 7 includes a power battery. The motor controller 8 (Motor Control Unit) is used to control the rotation of a motor. The first conductive member 4a and the second conductive member 4b are connected between the power module 7 and the motor controller 8 as the positive transmission line and the negative transmission line, respectively.

In summary, the electric drive assembly in this embodiment disposes the plurality of conductive members 4 of the terminal block 1 of the terminal connector and the filter part 3 in the housing 2, and respectively disposes the first connection end 11 and the second connection end 12 at the two ends of the extension body 13 to conduct current. Thus, a plurality of first segments 41 are disposed on the extension body 13, and the plurality of first segments 41 are arranged at intervals to form the intermediate component 14 disposed inside the magnetic ring 31. This allows the conductive member 4 to pass through the magnetic ring 31 multiple times via the intermediate component 14, thereby increasing the coupling strength between the terminal block 1 and the magnetic ring 31 and improving the filtering effect of the magnetic ring 31 on common-mode noise. On the other hand, it avoids the need to set capacitors on the terminal connector. Thereby, the structure of the terminal connector is simplified, and its volume is made more compact.

In an optional implementation, the electric drive assembly in the above embodiments can be applied to a vehicle. The vehicle may be a pure electric vehicle or a hybrid electric vehicle.

In summary, the vehicle in this embodiment disposes the plurality of conductive members 4 of the terminal block 1 of the terminal connector and the filter part 3 in the housing 2, and respectively disposes the first connection end 11 and the second connection end 12 at the two ends of the extension body 13 to conduct current. Thus, a plurality of first segments 41 are disposed on the extension body 13, and the plurality of first segments 41 are arranged at intervals to form the intermediate component 14 disposed inside the magnetic ring 31. This allows the conductive member 4 to pass through the magnetic ring 31 multiple times via the intermediate component 14, thereby increasing the coupling strength between the terminal block 1 and the magnetic ring 31 and improving the filtering effect of the magnetic ring 31 on common-mode noise. On the other hand, it avoids the need to set capacitors on the terminal connector. Thereby, the structure of the terminal connector is simplified, and its volume is made more compact.

The foregoing descriptions of specific embodiments of the present disclosure have been presented for purposes of illustration and description. They are not intended to be exhaustive or to limit the present disclosure to the precise forms disclosed, and obviously, many modifications and variations are possible in light of the above teaching. The embodiments were chosen and described in order to best explain the principles of the present disclosure and its practical application, thereby enable others skilled in the art to best utilize the present disclosure and various embodiments with various modifications as are suited to the particular use contemplated. It is intended that the scope of the present disclosure be defined by the claims appended hereto and their equivalents.

I/We claim:

1. A terminal connector, wherein the terminal connector comprises:
a housing;
a filter part, disposed in the housing and comprising a magnetic ring; and
a terminal block, disposed in the housing and comprising a plurality of spaced-apart conductive members, the conductive member comprising a first connection end, a second connection end, and an extension body, at least a portion of the first connection end and at least a portion of the second connection end is exposed outside the housing;
wherein the extension body extends from the first connection end to the second connection end and comprises, in an extension direction, a plurality of first segments, the plurality of first segments are arranged at intervals to form an intermediate component, the plurality of intermediate assemblies are inserted through the magnetic ring along an axial direction of the magnetic ring and coupled with the magnetic ring.

2. The terminal connector according to claim 1, wherein the magnetic ring comprises a first sidewall in a circumferential direction, an inner surface of the magnetic ring forms a central hole, the intermediate component is located in the central hole;
the extension body extends curvilinearly and winds around the first sidewall for multiple turns, the first connection end and the second connection end extend out from two ends of the central hole.

3. The terminal connector according to claim 2, wherein the extension body further comprises, in the extension direction:
At least one connection segment; and
an extension section, curved to form an accommodation gap, the accommodation gap having a first opening, orientations of the first openings of each the conductive member are same, the extension section comprising the first segment, a portion of the first sidewall is disposed spaced apart within the accommodation gap;
the connection segment is located on a side of the extension section where the first opening is disposed, the extension section is electrically connected to the first connection end or the second connection end via the connection segment.

4. The terminal connector according to claim 3, wherein the extension body comprises, in the extension direction, a plurality of the extension sections arranged at intervals, and in an arrangement direction of the plurality of extension sections, a plurality of the accommodation gaps of the same the conductive member at least partially overlap and correspond to the first sidewall.

5. The terminal connector according to claim 3, wherein the extension section further comprises:
a second segment; and
a third segment, disposed outside the magnetic ring, the third segment and the first segment extend parallel to each other along the axial direction of the magnetic ring and are connected by the second segment, a portion of the first segment has a first connection tab, the third segment has a second connection tab, the first connection tab and the second connection tab are located on a side of the extension section away from the second segment, each the first connection tab is located on the same side of the conductive member, the plurality of first segments comprise a side segment, the side segment is located on the same side as each the extension section, and one end of the side segment is connected to the first connection end, and the other end of the side segment forms the first connection tab;
the extension body is configured such that the connection segment is connected between two adjacent the extension sections or between an adjacent the side segment and the extension section, and two ends of the connection segment are connected to the first connection tab and the second connection tab respectively.

6. The terminal connector according to claim 5, wherein the conductive member comprises two the extension sections, two the connection segments, and the side segment, the first segment of the extension section away from the side segment is connected to the second connection end, the extension section close to the side segment is connected to one end of the side segment via the connection segment, and the other end of the side segment is connected to the first connection end.

7. The terminal connector according to claim 5, wherein the connection segment comprises a first connection block, a second connection block, and a bent region connected between the first connection block and the second connection block;
the first connection block is connected to the first connection tab and lies in the same plane as the first connection tab, the second connection block is connected to the second connection tab and lies in the same plane as the second connection tab, the bent region bends from one the plane to an adjacent the plane.

8. The terminal connector according to claim 5, wherein the housing is an injection-molded part and has an accommodation ring groove, the accommodation ring groove surrounds the intermediate component;
a portion of the terminal block is disposed as an insert in the housing, and the first connection tab and the second connection tab protrude from the housing.

9. The terminal connector according to claim 8, wherein a connection window is formed between the first connection tab and the second connection tab corresponding to the same the connection segment;
the magnetic ring passes through the connection window and is disposed in the accommodation ring groove, and the connection segment is disposed at the connection window.

10. The terminal connector according to claim 9, wherein the terminal connector further comprises a cover part, the cover part comprises a cover body, the cover body is provided with an avoidance window;
the cover part passes through the connection window and covers the accommodation ring groove, and the first connection tab and the second connection end protrude from the avoidance window.

11. The terminal connector according to claim 9, wherein the magnetic ring further comprises, in the circumferential direction, a second sidewall connected to the first sidewall;
the connection window has a first window edge disposed at the first connection tab and a second window edge disposed at the second connection tab, the first window edge and the second window edge are opposite to each other and parallel to the axial direction of the magnetic ring, the first window edge and the second window edge are respectively welded to two ends of the connection segment;
in an arrangement direction of the third segment and the first segment, the first window edge and the second window edge of the connection window away from the second sidewall are located between the first window edge and the second window edge of the connection window close to the second sidewall.

12. The terminal connector according to claim 9, wherein the connection window has a third window edge disposed at the first connection tab and a fourth window edge disposed at the second connection tab;
the third window edge and the fourth window edge extend along an arrangement direction of the first segment and the third segment, and opposite sides of the third window edge and the fourth window edge form the first opening, a side edge of the connection segment is spliced with the third window edge and the fourth window edge and faces an end surface of the magnetic ring through the first opening.

13. The terminal connector according to claim 2, wherein the plurality of conductive members comprise a first conductive member and a second conductive member;
the magnetic ring further comprises, in the circumferential direction, a second sidewall and a third sidewall, the third sidewall is spaced apart from and opposite to the first sidewall, the second sidewall is connected between the third sidewall and the first sidewall;
the extension body of the first conductive member winds around the first sidewall, the extension body of the second conductive member winds around the second sidewall, an extension direction of the extension body of the first conductive member is opposite to an extension direction of the extension body of the second conductive member, and the number of turns of the first conductive member and the second conductive member is the same.

14. The terminal connector according to claim 13, wherein the filter part further comprises:
an intermediate magnetic body, disposed spaced apart between the first conductive member and the second conductive member, and the intermediate magnetic body is coupled with the first conductive member, the second conductive member, and the magnetic ring.

15. The terminal connector according to claim 14, wherein the intermediate magnetic body is a plate-like structure, the plate-like structure has a first plate surface and a second plate surface;
the first plate surface faces the first sidewall, a first coupling space is formed between the first plate surface and the first sidewall, the second plate surface faces the third sidewall, a second coupling space is formed between the second plate surface and the third sidewall;
the intermediate component of the first conductive member and the intermediate component of the second conductive member are located in the first coupling space and the second coupling space, respectively.

16. The terminal connector according to claim 15, wherein the housing has a mounting groove, the mounting groove comprises an accommodation ring groove and an intermediate groove communicating with each other, the intermediate groove is located at a center of the accommodation ring groove and located between two the intermediate assemblies;
the magnetic ring is disposed in the accommodation ring groove, the intermediate magnetic body is disposed in the intermediate groove, and part of filling gap is formed between the filter part and an inner wall of the mounting groove;
the terminal connector further comprises a filling adhesive, the filling adhesive fills the filling gap.

17. The terminal connector according to claim 16, wherein a portion of the first segment has a first connection tab;
the terminal connector further comprises a cover part, the cover part comprises a cover body and a partition plate, the cover body is provided with an avoidance window;
the cover body covers the accommodation ring groove, the first connection tab and the second connection end protrude from the avoidance window, the partition plate is simultaneously located between two the intermediate assemblies and between two the second connection ends, and a plate edge of the partition plate extends into the intermediate groove, the filling gap is formed between the magnetic ring and the mounting groove and the cover body.

18. The terminal connector according to claim 13, wherein a cross-section along an extending direction of the central hole is a rounded rectangle, the first sidewall and the third sidewall form two short sides of the rounded rectangle, respectively;
two the intermediate assemblies are arranged along a long side of the rounded rectangle, the plurality of first segments of the same the intermediate component are arranged along a short side of the rounded rectangle.

19. An electric drive assembly, wherein the electric drive assembly comprises:
a power module;
a motor controller; and
a terminal connector according to claim 1, wherein the first connection end is connected to the power module, and the second connection end is connected to the motor controller.

20. The electric drive assembly according to claim 19, wherein the magnetic ring comprises a first sidewall in a circumferential direction, an inner surface of the magnetic ring forms a central hole, the intermediate component is located in the central hole;
the extension body extends curvilinearly and winds around the first sidewall for multiple turns, the first connection end and the second connection end extend out from two ends of the central hole;
wherein the extension body further comprises, in the extension direction:
at least one connection segment; and
an extension section, curved to form an accommodation gap, the accommodation gap having a first opening, orientations of the first openings of each the conductive member are same, the extension section comprising the first segment, a portion of the first sidewall is disposed spaced apart within the accommodation gap;
the connection segment is located on a side of the extension section where the first opening is disposed, the extension section is electrically connected to the first connection end or the second connection end via the connection segment.
